(19) United States
(12) Patent Application Publication
(10) Pub. No.: US 2013/0185651 A1
(43) Pub. Date: Jul. 18, 2013

(54) PEOPLE PRESENCE DETECTION IN A MULTIDOCUMENT KNOWLEDGE BASE

(71) Applicants: Thomas K.B. Wionzek, Santa Fe, NM (US); Suresh Sitaula, Bellevue, WA (US); Sattawat Suppalertporn, Redmond, WA (US); Gary L. Neitzke, Duvall, WA (US); David C. Tse, Kirkland, WA (US); Daniel Escapa, Redmond, WA (US); Nicole D. Steinbok, Sammamish, WA (US)

(72) Inventors: Thomas K.B. Wionzek, Santa Fe, NM (US); Suresh Sitaula, Bellevue, WA (US); Sattawat Suppalertporn, Redmond, WA (US); Gary L. Neitzke, Duvall, WA (US); David C. Tse, Kirkland, WA (US); Daniel Escapa, Redmond, WA (US); Nicole D. Steinbok, Sammamish, WA (US)

(73) Assignee: MICROSOFT CORPORATION, Redmond, WA (US)

(21) Appl. No.: 13/352,359

(22) Filed: Jan. 18, 2012

(51) Int. Cl. G06F 3/00

(52) U.S. Cl. 715/753

(57) ABSTRACT

User presence is detected in a notebook that includes multiple different documents. The user identity and location within the notebook can be displayed to other users to facilitate collaboration.

### BACKGROUND

There are a wide variety of different types of knowledge base that are currently in use, and that contain multiple documents. One type of knowledge base is a notebook system that supports note taking applications. In such a system, it is not uncommon for there to be multiple different notebooks, each of which are arranged in a generally hierarchical fashion. Each notebook can have multiple different sections or chapters, and each section can have multiple different pages. Each page can have multiple different documents located thereon or embedded therein.

For instance, in one notebook system, a notebook may be created that corresponds to a given product. The notebook can have different tabs associated with different sections, and those sections may include, for instance, a section devoted to customers for the product, a section devoted to the product specification, a section devoted to meetings that are to be scheduled or that have been scheduled regarding the product, a home section or home page that generally describes the product, etc.

Each of the sections may contain a plurality of different pages, and each page can contain one or more documents. With respect to the present discussion, the term document means a collection of content. For instance, a document may be a word processing document or a page in the document, or it may be a spreadsheet or even a page in the spreadsheet, a video or audio file, a slide presentation or individual slides in the presentation, a set of drawings in a drawing document or the individual drawings, or any other similar type of content collection. It can be seen that a page in a given notebook may have one or more documents contained thereon. In addition, one document can be embedded within another. For instance, a slide presentation document may have a spreadsheet document embedded therein. In any case, it can be seen that such notebook systems can represent a knowledge base that contains a wide variety of different documents, and even different types of documents.

The discussion above is merely provided for general background information and is not intended to be used as an aid in determining the scope of the claimed subject matter.

### SUMMARY

When a notebook system is accessible by a number of different users, user collaboration can be supported in the notebook. For instance, one user may access a certain section or page of the notebook, and begin editing that section, while another user accesses a different notebook in the system or a different section or page or document and is editing that portion of the same notebook. In this type of collaboration, it can be helpful for a user who is working in, or accessing, a notebook to be aware of the presence of other users who are also working in, or accessing, the notebook or in another notebook in the system.

User presence is detected in a notebook that includes multiple different documents. The user identity and location within the notebook can be displayed to other users to facilitate collaboration.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a collaboration system.

FIG. 2 is a flow diagram illustrating one embodiment of the overall operation of the system shown in FIG. 1 in detecting presence of users in a notebook.

FIG. 3 is a flow diagram illustrating one embodiment of the operation of the system shown in FIG. 1 in generating a global map showing detected presence in each of a plurality of different notebooks.

FIGS. 4A-4B show one illustrative flow diagram of the operation of the system shown in FIG. 1 in performing presence information processing.

FIGS. 5A-5O are illustrative user interface displays.

FIGS. 6-8 show illustrative mobile devices which can be used.

FIG. 9 is a block diagram of one illustrative computing environment.

### DETAILED DESCRIPTION

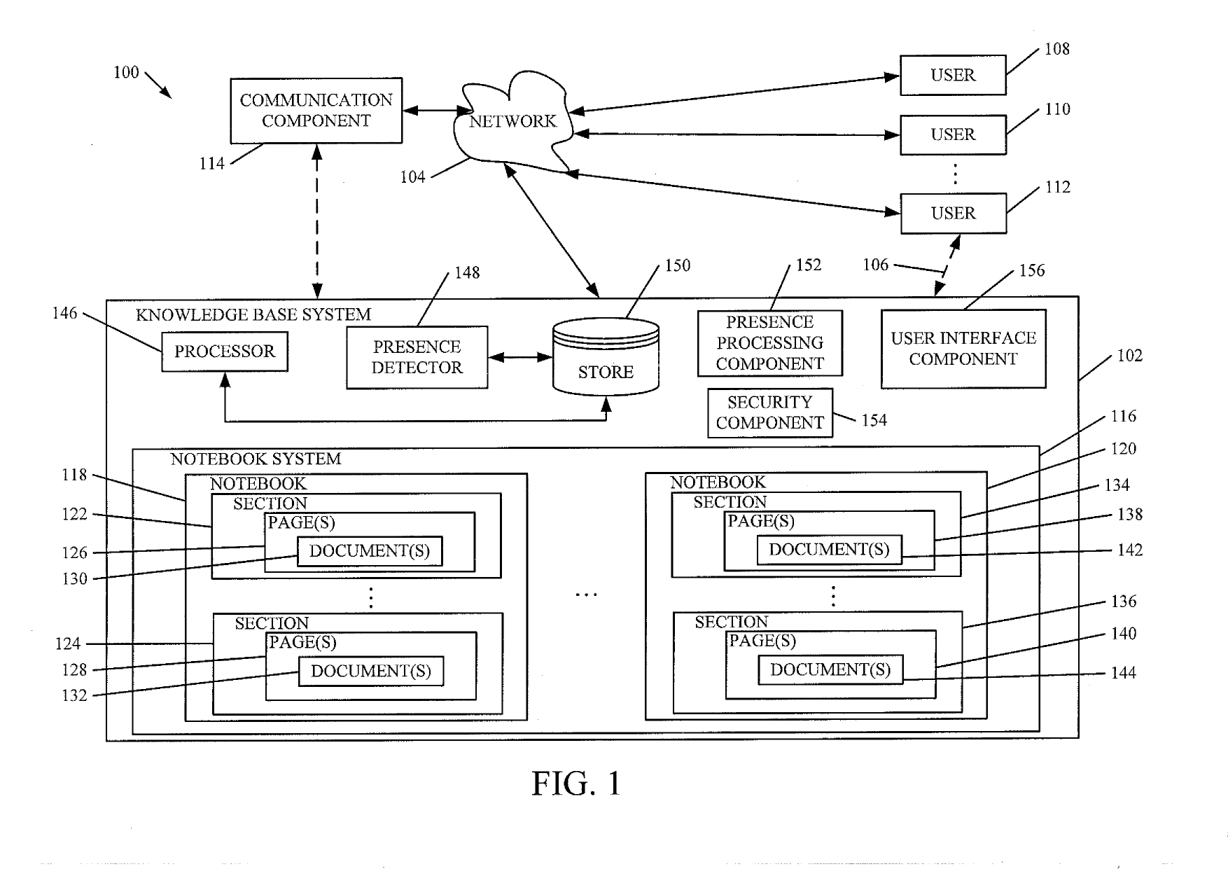

FIG. 1 is a block diagram of a collaboration system 100. Collaboration system 100 shows a knowledge base system 102 connected either through network 104 or directly (as indicated by dashed arrow 106) to a plurality of users 108, 110 and 112 that collaborate on collections of documents in knowledge base system 102. FIG. 1 also shows that users 108-110 can be connected with one another and with knowledge base system 102 through a communication component 114.

In the embodiment shown, knowledge base system 102 illustratively supports a notebook system 116 that, itself, supports a plurality of notebooks 118-120. Each notebook illustratively includes a hierarchical arrangement of content. In the embodiment shown in FIG. 1, notebook 118, for instance, includes a plurality of sections 122 and 124. Each section illustratively has a plurality of pages 126 and 128 and each of the pages illustratively includes one or more documents 130 and 132. Also, by way of example, notebook 120 illustratively includes sections 134 and 136, each of which includes one or more pages 138 and 140, each page including one or more documents 142 and 144. For the sake of the present discussion, as mentioned above, the term documents not only includes word processing document files, but also includes other collections of content. For instance, the term document includes video clips, audio clips, individual pages in the notebook, slideshow presentations, spreadsheets, drawings in a drawing program and other collections of content.

Knowledge base system 102 also illustratively includes a processor 146 which can be a computer processor with associated timing circuitry and memory (not shown). Processor 146 is operably coupled to, and activated by, other components in system 100 to facilitate their function. Knowledge base system 102 also illustratively includes a presence detector 148, presence detector data store 150, presence processing component 152, security component 154 and user interface component 156. Any or all of these components can be part of notebook system 110, although they are shown separately.

The detailed operation of system 102 is described below. Briefly, however, the plurality of users 108-112 can access, through system 102, one of notebooks 118 and 120. Users 108-112 can illustratively collaborate on the notebook by editing pages or documents in the various notebooks in notebook system 116. When a user (such as user 108) accesses a notebook (such as notebook 118) presence detector 148 illustratively detects, at some point, that the specific user 108 is at a specific location in notebook 118, and logs that information in store 150. Presence detector 148 illustratively detects the presence and location of all the various users 108-112 in all of the various notebooks 118-120 and logs corresponding user presence information in store 150. Presence processor component 152 can then perform a wide variety of different operations using the user presence information stored in store 150. In doing so, user interface component 156 generates user interfaces that can be used to display information to, and receive information from, users 108-112.

By way of example only, assume that user 108 is accessing document 130 in notebook 118, and presence detector 148 has detected that and stored that information in data store 150. Next, assume that user 110 logs on to the system and accesses notebook system 116 as well. In that case, presence processing component 152 illustratively generates a user interface display using user interface component 156 that displays the identity and location of user 108 within notebook system 116, to user 110. For instance, the user interface display generated by component 156 may include an icon for each of notebooks 118-120 in system 116. The display may also include a presence detection icon located near the icon for notebook 118, indicating that another user is using notebook 118. The presence detection icon may convey the identity of that particular user (the identity of user 108) or it may simply indicate that a user has been detected at that location. Security component 154 can be used to determine whether the identity of a given user (or even that user's presence) will be detected or displayed. In addition, component 152 can generate a display using component 156 that shows user 108 that another user 110 has just accessed notebook system 116 as well. Of course, these are but two operations performed by system 102, and others are described below.

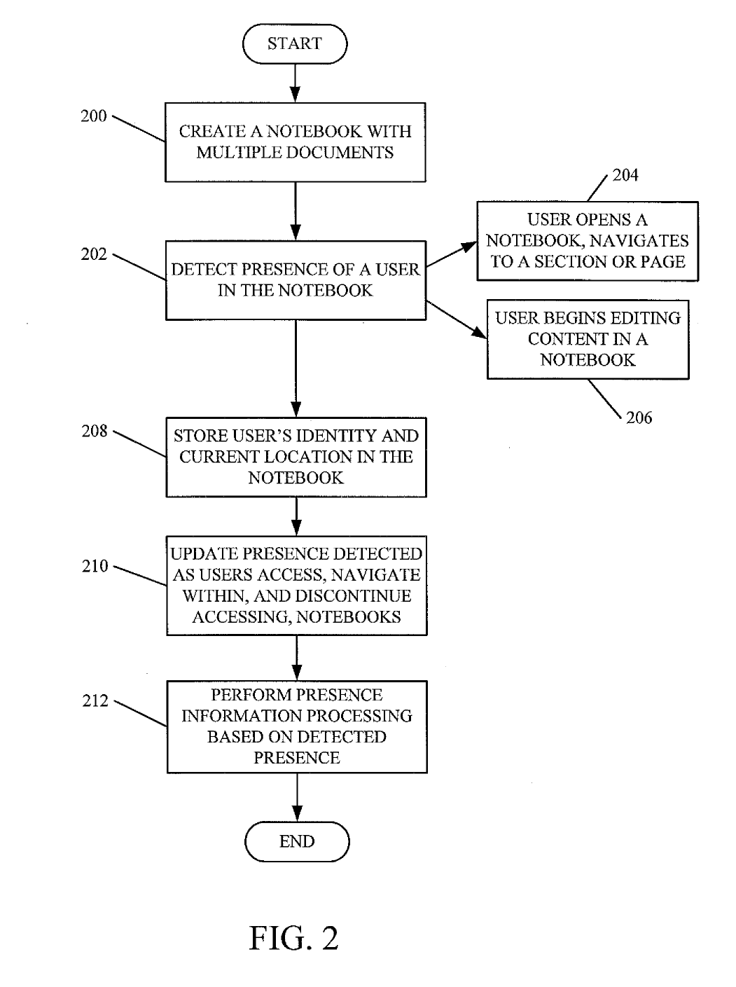

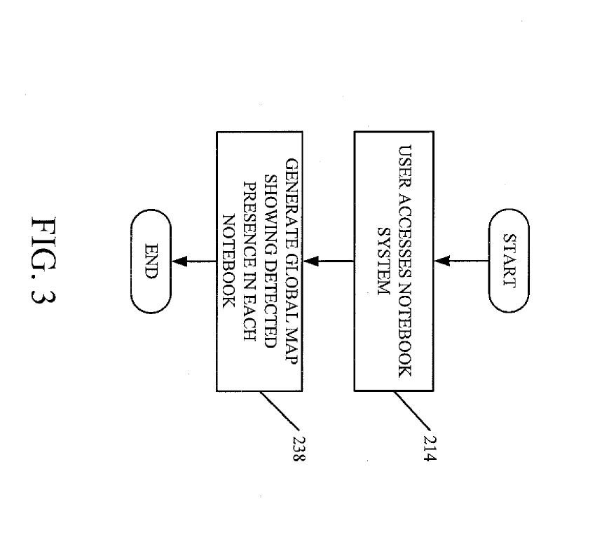

FIG. 2 is a flow diagram showing one illustrative embodiment of the operation of system 102 in detecting presence of a user 108-112 at a location in notebook system 116. One of users 108-112 first uses knowledge base system 102 to create a notebook 118-120. The user then arranges sections within that notebook and adds pages and documents to the notebook. This is indicated by block 200 in FIG. 2.

At some point, one of the user's (for example user 110) accesses that notebook (for example notebook 118) in system 116. In doing so, user 110 illustratively provides logon or authentication information to system 102 in order to gain access to notebook 118. Notebook system 116 then navigates the user 110 to a desired section and page, or to a document, within notebook 118. At some point, presence detector 148 detects the presence of user 110 and the location of user 110, within notebook 118. Detecting the presence of a user in notebook 118 is indicated by block 202 in FIG. 2.

Presence detector 148 can operate in a wide variety of different ways. For instance, when user 110 accesses system 102, presence detector 148 illustratively logs the identity of user 110 in data store 150. Then, when the user opens notebook 118 and navigates to a section or page within notebook 118, presence detector 148 can log the location, where user 110 has navigated to, in data store 150 as well. This is indicated by block 204 in FIG. 2.

However, presence detector 148 can operate in a different way as well. For instance, presence detector 148 may operate in a way in which the identity of user 110 and the user's location in notebook 118, are not detected as a “user presence” until user 110 actually beings editing the documents 130-132 in notebook 118. Then, once that happens, presence detector 148 logs the identity of user 110 and the particular location in notebook 118 where user 110 has begun editing, in data store 150. This is indicated by block 206 in FIG. 2. Of course, presence detector 148 can use other user interactions to trigger presence detection as well and the two shown in FIG. 2 are given for the sake of example only. Storing the identity of user 110 and the current location of user 110 within notebook 118 is indicated by block 208.

In accordance with one embodiment, presence detector 148 continues to update the detected presence of users 108-112, and their location, within notebook system 116. Therefore, as the users log on to system 102 and access notebooks 118-120, presence detector 148 detects the presence of those users and their location within system 116, and stores it in data store 150. Similarly, as users logoff or discontinue access of notebook system 116, presence detector 148 updates the information to indicate that those users are no longer in notebook system 116. Updating the presence detector as users access, change locations in, and discontinue access to, notebook system 116 is indicated by block 210 in FIG. 2.

Presence processing component 152 accesses the presence information in data store 150 and performs a wide variety of different types of processing based upon the detected presence within notebook system 116.

In one embodiment, component 152 accesses data store 150 according to a set of heuristics. These can be set as desired. For instance, every time a given display opens, component 152 can access data store 150 for updated presence information. Alternatively, or in addition, the displays (like the numbers adjacent the icons) can be updated on a time basis, such as every ten minutes. They can also be updated based on other user-driven events such as the user navigating to another notebook. These are given by way of example only.

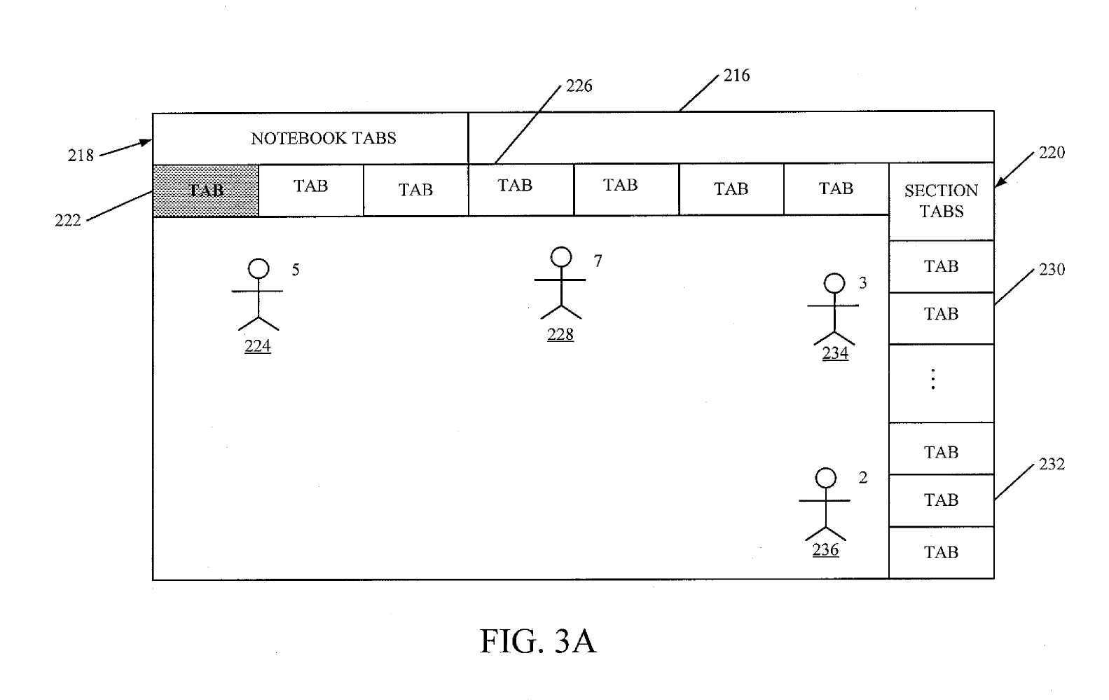

A number of different examples of the type of processing performed by presence processing component 152 are discussed below with respect to FIGS. 3-50. Performing presence information processing is indicated by block 212 in FIG. 2.

FIG. 3 is a flow diagram illustrating one embodiment of the operation of system 102 in generating a user interface display for a user that initially logs on to, or accesses, notebook system 116. FIG. 3A is one illustrative user interface display. FIGS. 1, 3 and 3A will now be described in conjunction with one another.

In the embodiment shown in FIGS. 3 and 3A, a user (such as user 108) logs onto system 102 and begins accessing notebook system 116. This is indicated by block 214 in FIG. 3.

In one embodiment, even before user 108 selects one of notebooks 118-120 for accessing, presence processing component 152 generates a display using user interface display component 156 that displays a global map showing where various other users are currently detected within notebook system 116. FIG. 3A shows one embodiment of a user interface display 216 that illustrates a global map. In the embodiment shown in FIG. 3A, user interface display 216 has a plurality of notebook tabs 218 displayed along a top portion of display 216, and a plurality of section tabs 220 displayed along a right side of display 216.

Tabs 218 illustratively include a tab corresponding to each of notebooks 118-120 in notebook system 116. When the user selects one of tabs 218, system 116 illustratively navigates the user to the notebook 118-120 corresponding to the selected tab. Similarly, tabs 220 correspond to the sections within a selected notebook corresponding to a selected tab 218. By way of example, if the user 108 hovers the cursor over (or selects) one of tabs 218, section tabs 220 are updated to show tabs, corresponding to sections, in the specific notebook corresponding to the tab 218 over which the user has hovered the cursor. For example, if the user hovers the cursor over specific tab 222, and tab 222 corresponds to notebook 118 in system 116, then section tabs 220 are updated to show tabs corresponding to the sections 122-124 in notebook 118.

Presence processing component 152 also illustratively generates icons that show the location of other users within system 116. This can be done in a variety of different ways. One exemplary way is to generate an icon next to a tab where a user is located. For instance, icon 224 shows that there are five people currently detected in notebook 118. This is because icon 224 has the number 5 next to it and it is displayed in close proximity to tab 222, which corresponds to notebook 118 in system 116.

Assume that notebook tab 226 corresponds to notebook 120 in system 116. In that case, display 216 shows that there are seven people detected within notebook 120, because icon 228 is disclosed proximate tab 226 and has the number 7 displayed next to it.

As shown in FIG. 3A, the user has hovered over, or selected, notebook tab 222, which corresponds to notebook 118 in system 116. That being the case, section tabs 220 correspond to sections 122 and 124 in notebook 118. Assume, for example, that tab 230 corresponds to section 122, and tab 232 corresponds to section 124. Display 216 shows not only that there are five people detected within notebook 118 (as shown by icon 224) but it also shows that three of those people are detected in section 122 (because icon 234 is displayed proximate tab 230) and that two of those people are detected in section 124 (because icon 236 is displayed proximate tab 232).

It will of course be appreciated that the display 216 shown in FIG. 3A is illustrative only. Instead of having notebook tabs displayed horizontally and section tabs displayed vertically, the displays could be arranged in different ways. Similarly, instead of having notebook tabs and section tabs, it may be that the global map only has notebook tabs. Alternatively, the global map may have additional tabs, such as notebook tabs, section tabs, page tabs, and even document tabs. Instead of having only a single column of section tabs 220 corresponding to a selected notebook tab 218, displays 216 may alternatively show all of the section, page and document tabs corresponding to each notebook tab 218. Any combination of these displays can be used as well.

Generating a global type of display can be done in other ways as well. For instance, a chat list can be displayed that shows people in a notebook along with presence information (such as “online” or “offline”) and location information. Such a list may be always displayed and/or docketed at one side of the screen, by way of example.

In another embodiment, a textual list can be displayed. This may be desired on mobile devices with relatively small screens. Such a list can take a wide variety of forms. By way of example, the display can show a “People” tab. When the tab is actuated by the user, a list can be displayed that shows real-time presence information for a notebook, in list form. One example of such a list is as follows:

Notebook 118

Section 122

Page 126

*user 108*

Section 134

Page 128

*user 110*

In any case, generating the global map showing the detected presence in each notebook is indicated by block 238 in FIG. 3.

Another way of showing detected presence is to simply generate a display element (such as an icon), that indicates that a certain number of people are present somewhere in notebook system 116. Then, if the user interacts with the icon, the location of those people is displayed. Other ways for showing detected presence are contemplated as well.

In addition, as described below, the user can illustratively interact with each of icons 224, 228, 234 and 236. For instance, if the user hovers over one of the icons (or selects it or otherwise interacts with it) then presence processing component 152 illustratively displays the identity of the users represented by the icon. Similarly, presence processing component 152 can display a communications button that allows the user to initiate communication with one of the other users represented by the icon. Similarly, the icons 224, 228, 234 and 236 can be different icons, other than those depicted in FIG. 3A. They can also be disclosed along with other effects, such as a shimmering effect, pulsating effect, a fireworks effect, etc. Further, they can be actuable icons which, when actuated by the user, display information in more detail, or navigate the user to a location of the other users represented by the icon, for example.

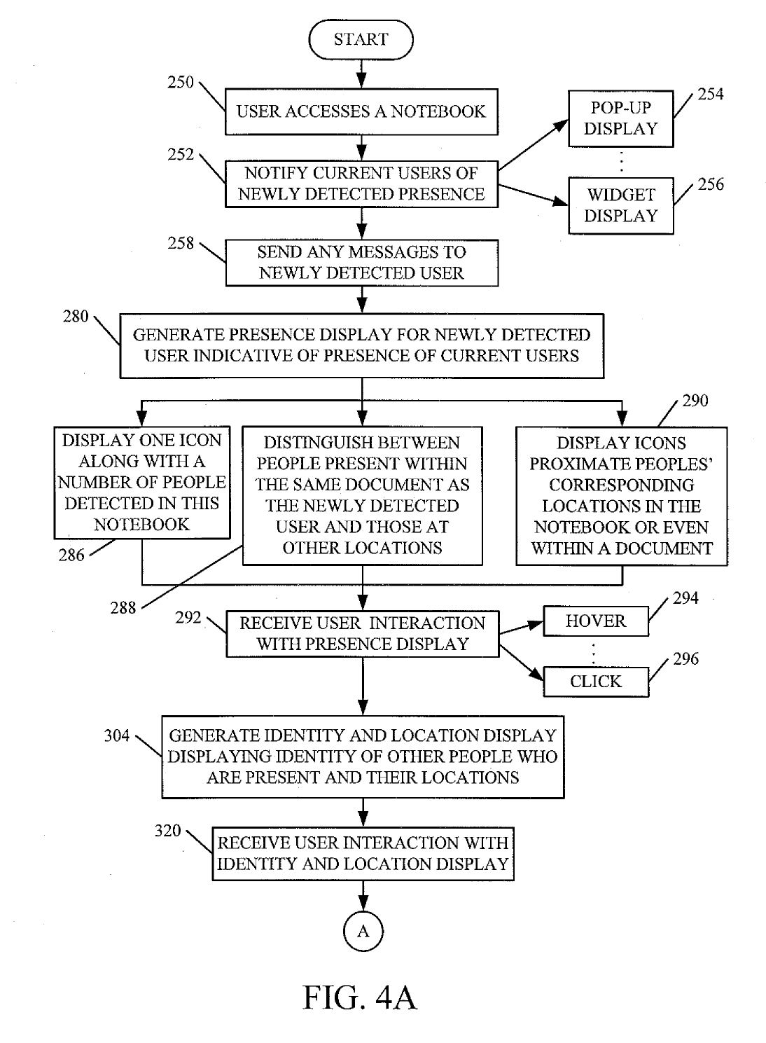

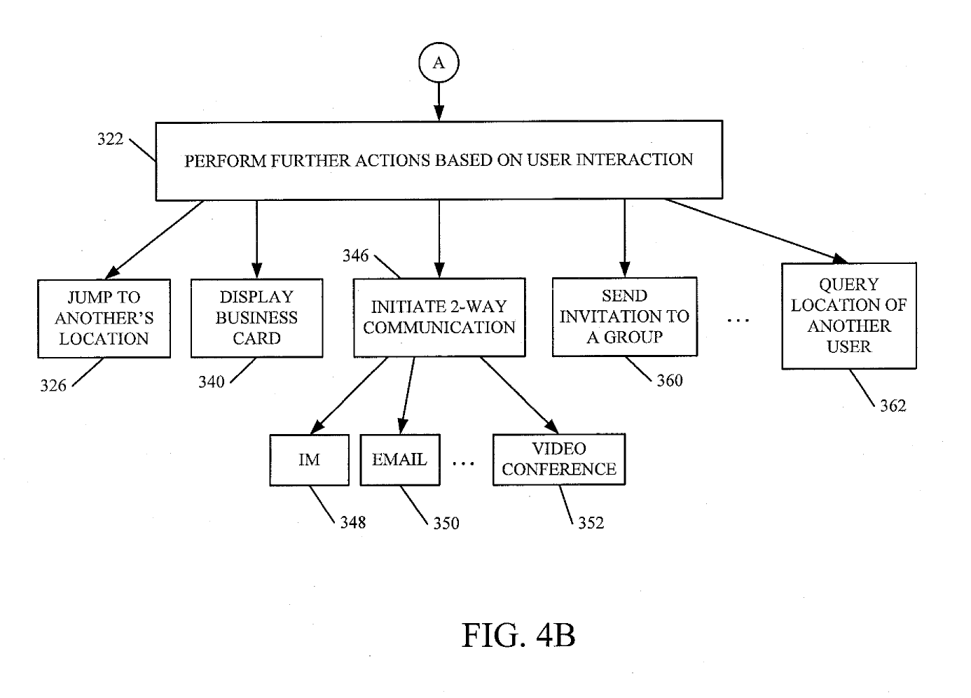

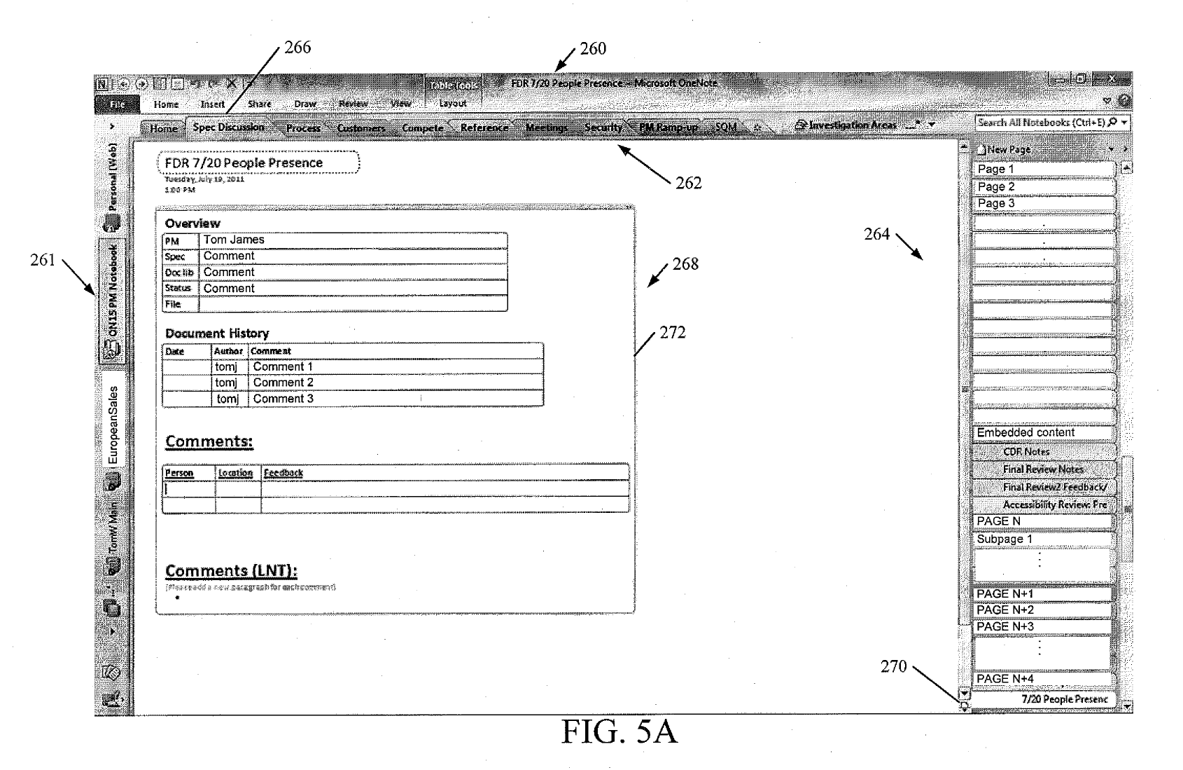

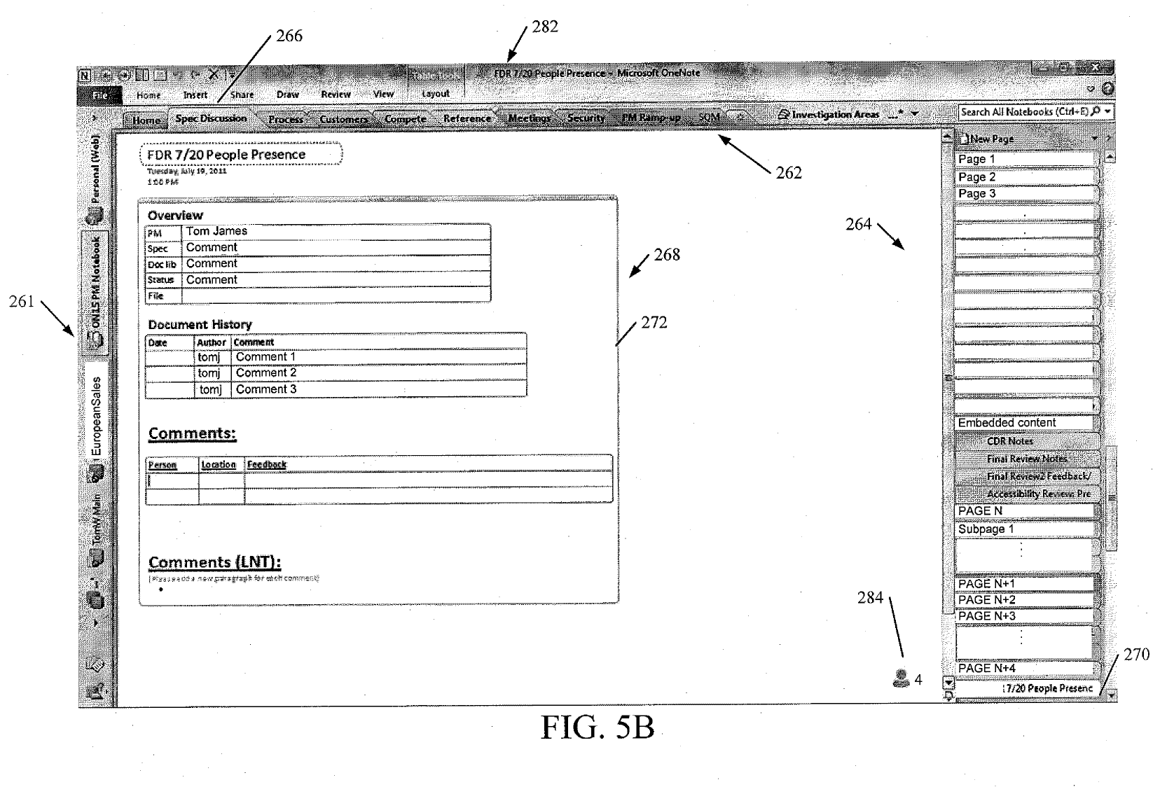

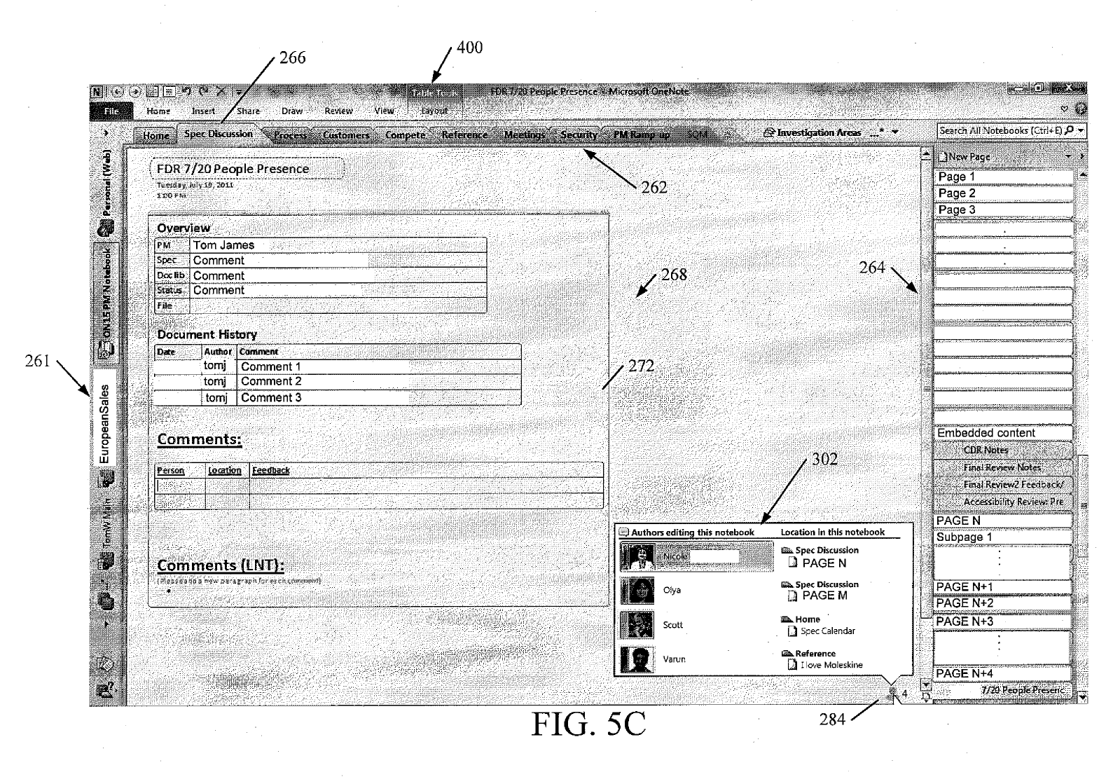

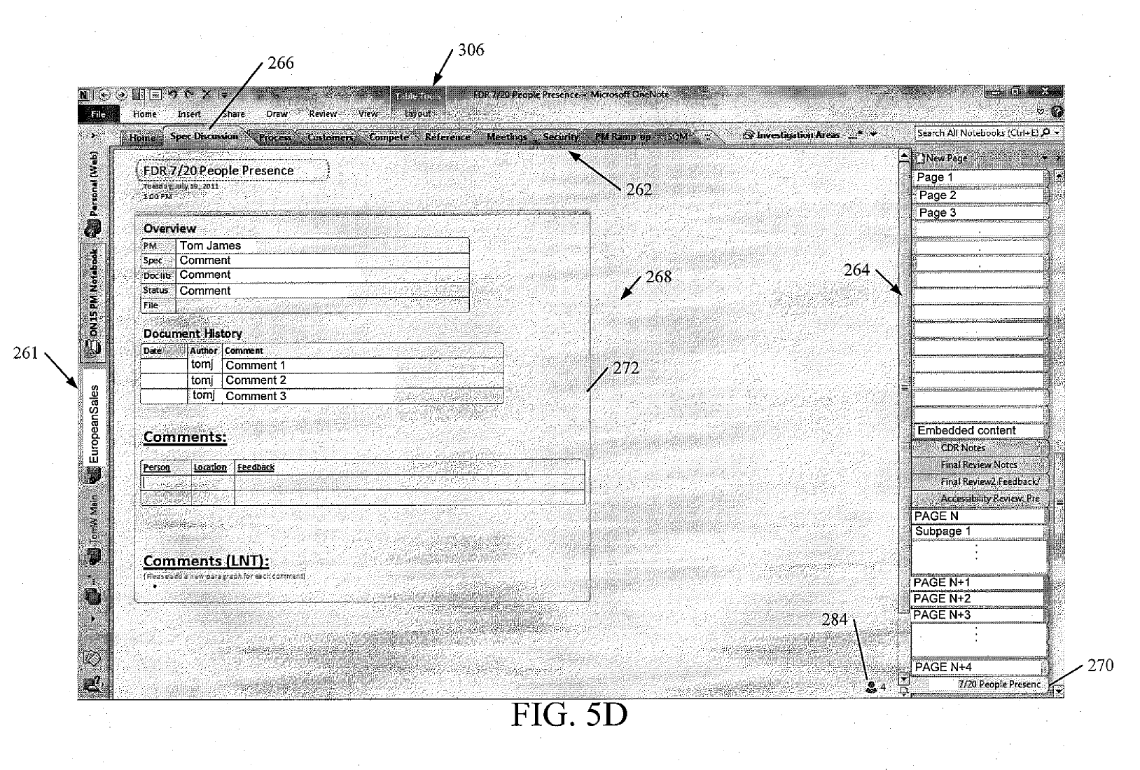

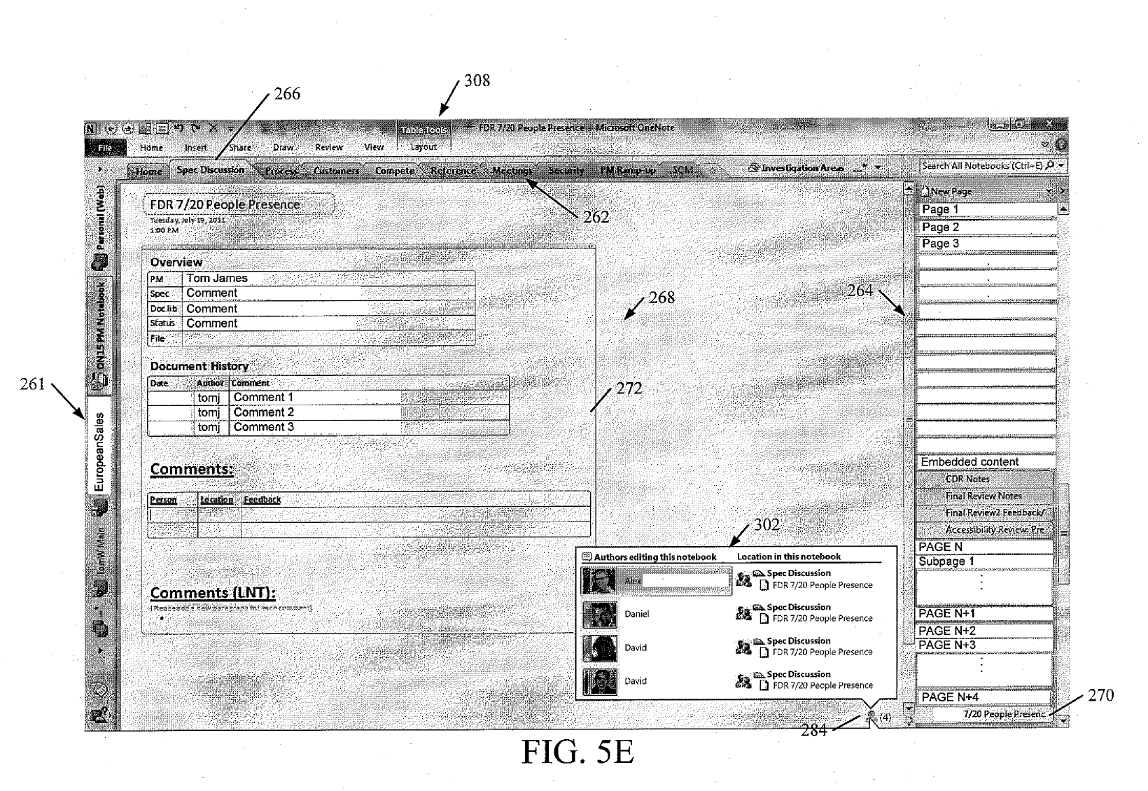

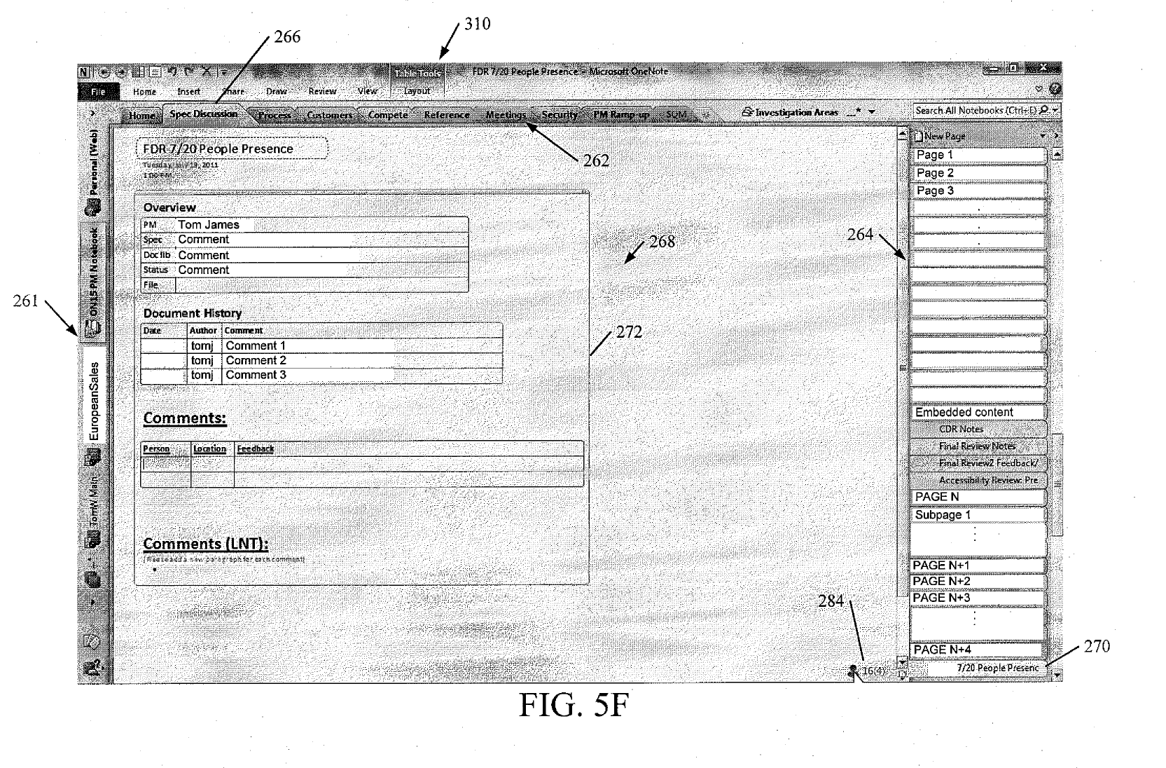

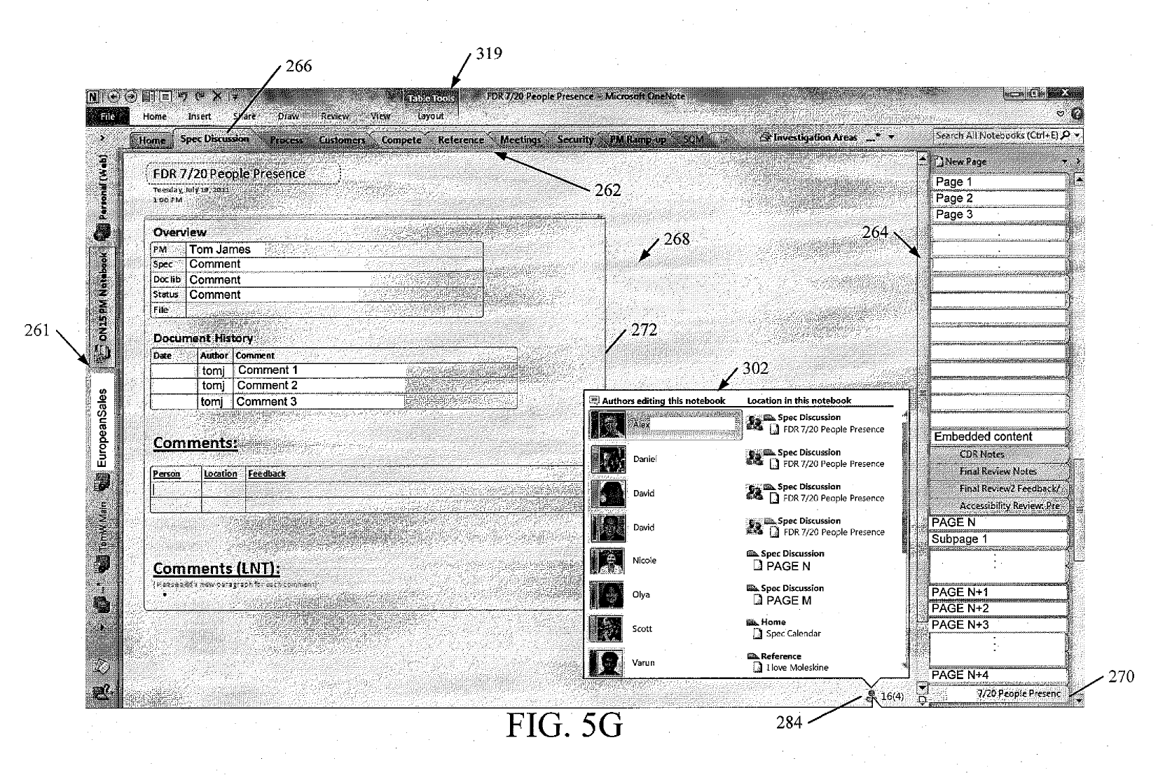

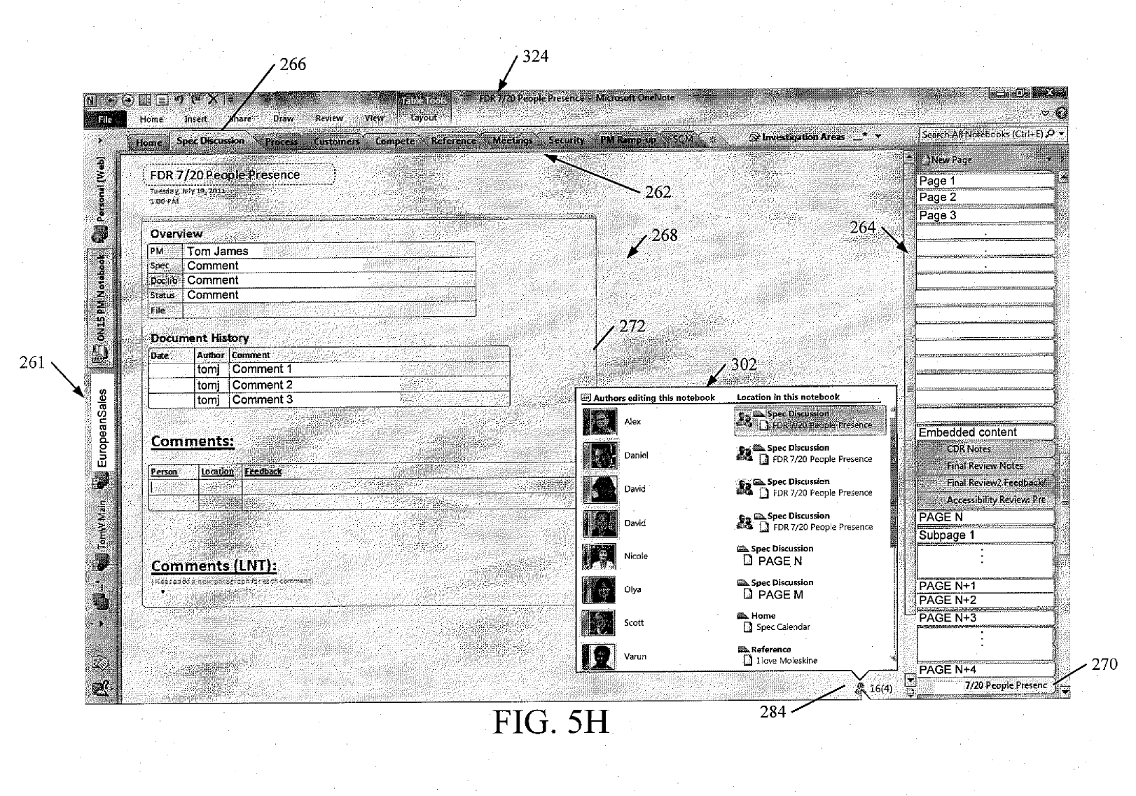

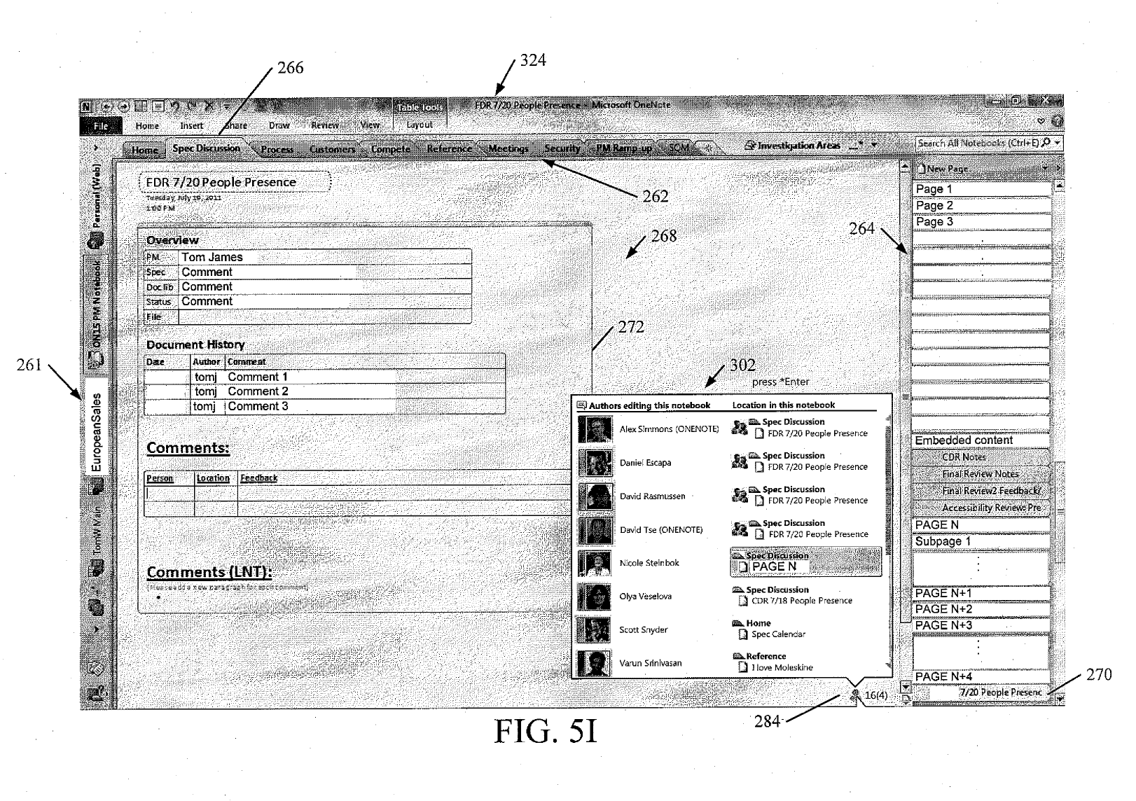

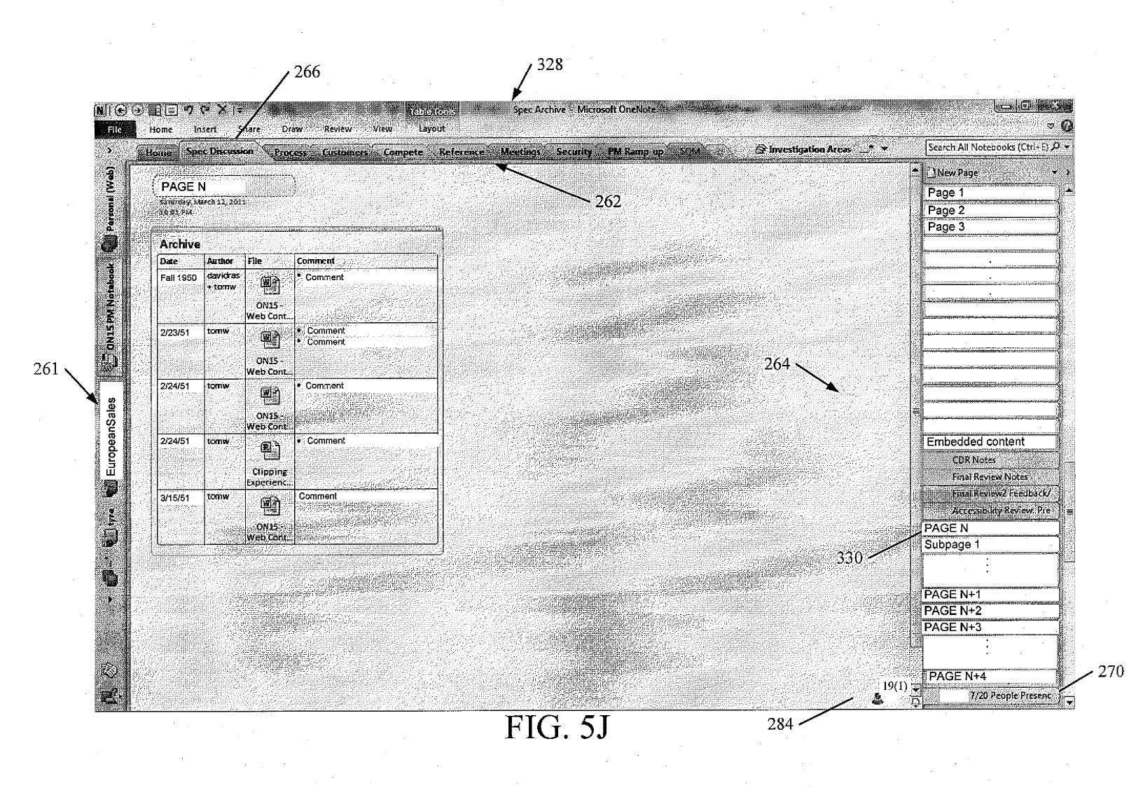

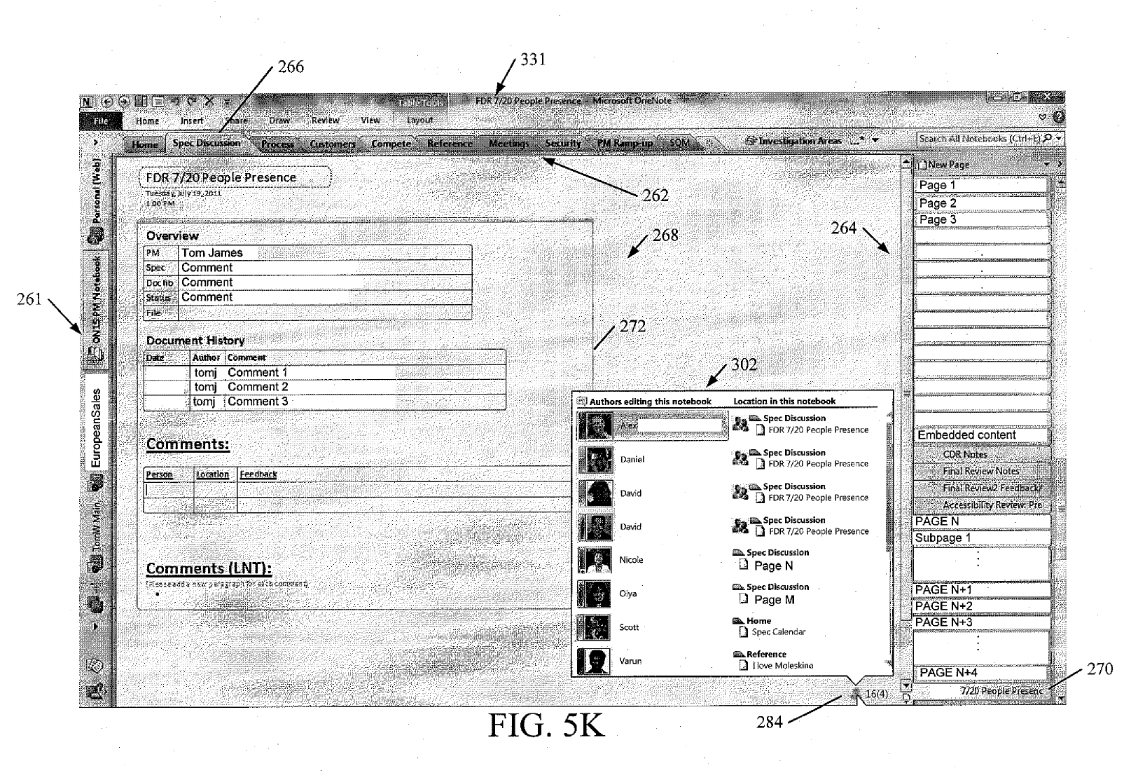

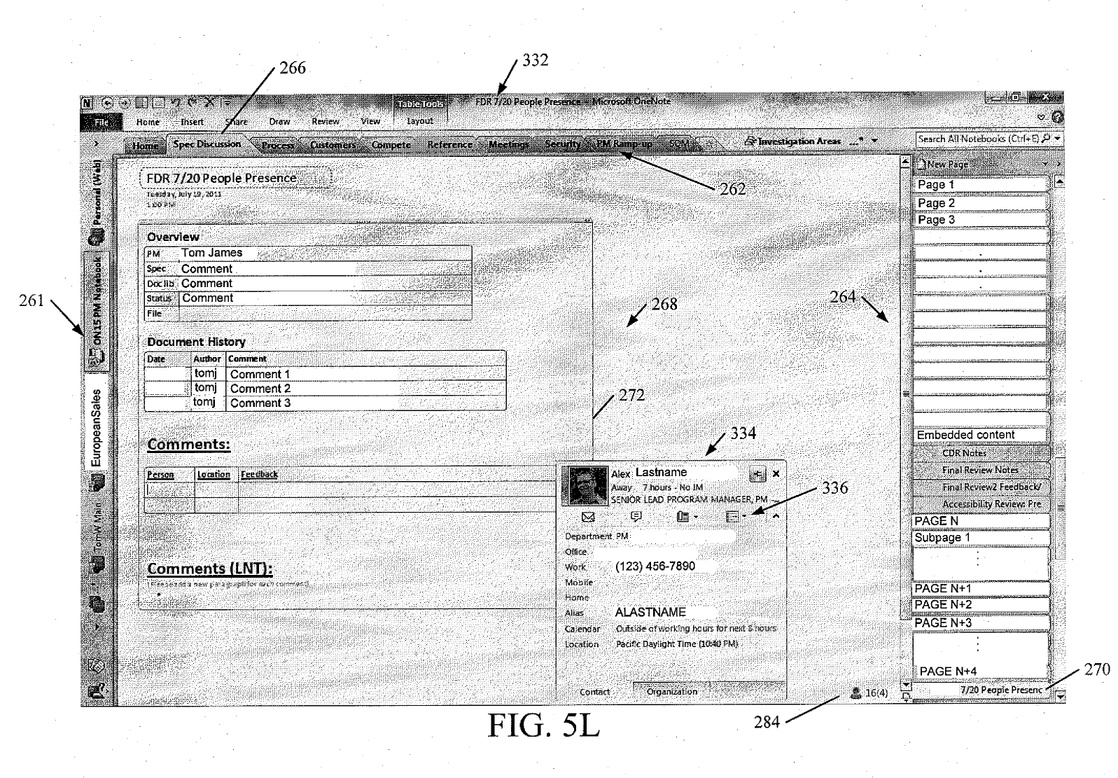

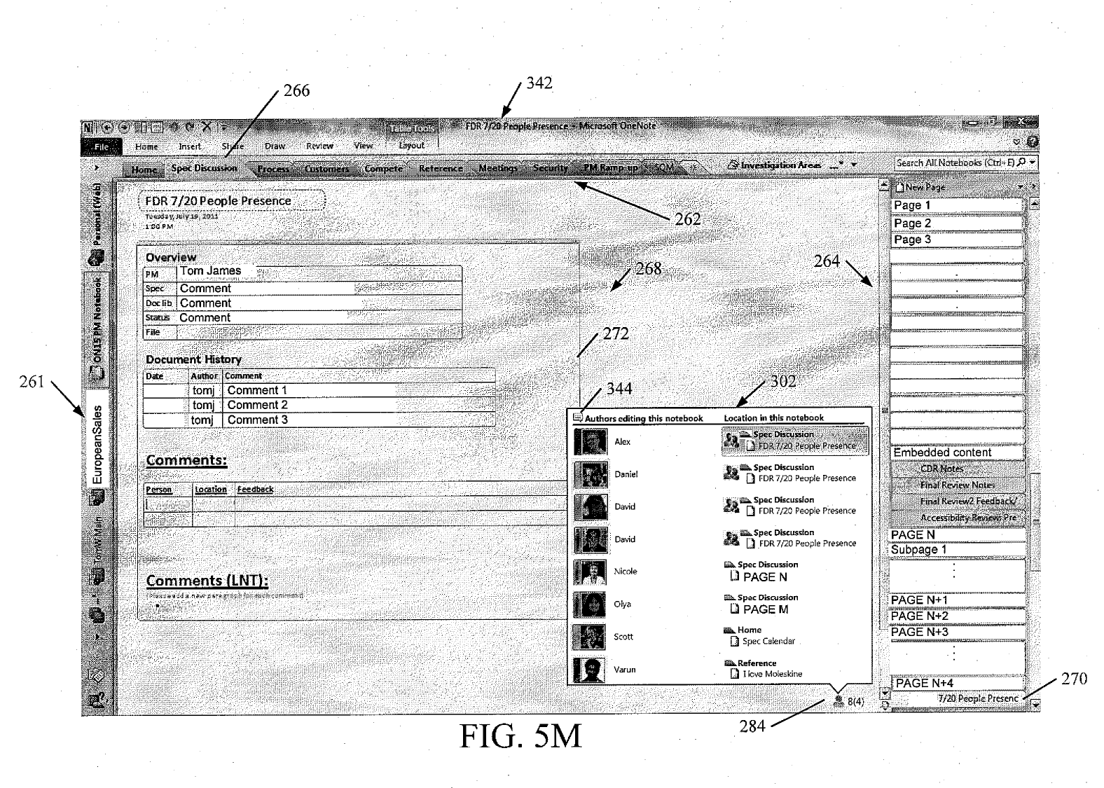

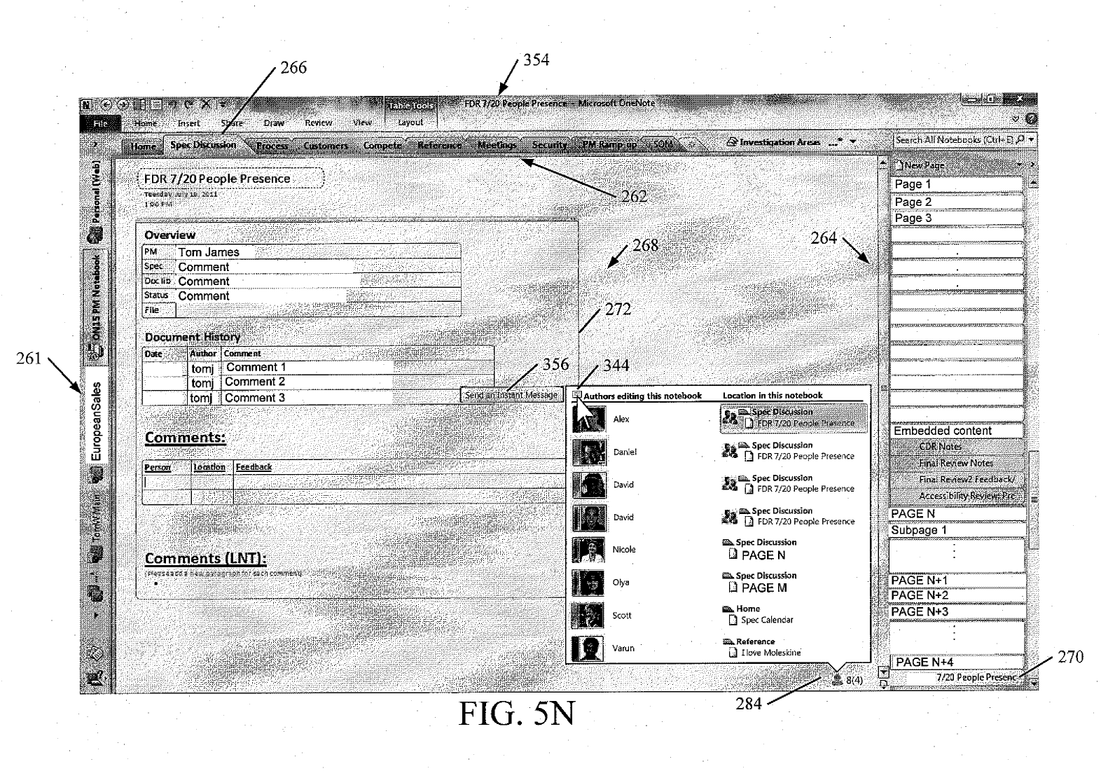

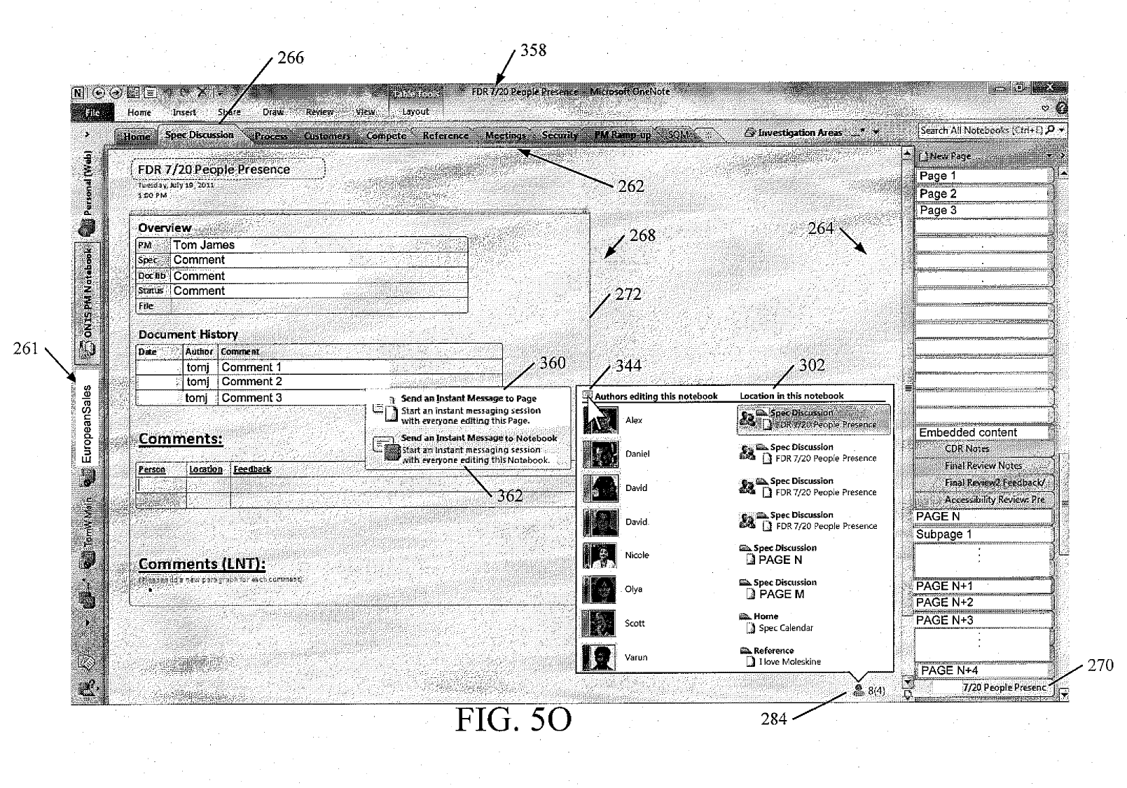

FIGS. 4A and 4B (collectively referred to as FIG. 4) show one illustrative flow diagram of the operation of system 102 where the user has accessed a specific notebook 118-120 within system 116. For instance, assume that user 108 has accessed system 116 and has been shown the global map illustrated in FIG. 3A. Assume also that user 108 has actuated a specific one of the notebook tabs 218 (such as tab 222) and that system 116 has then navigated the user to the corresponding notebook (such as notebook 118). FIG. 4 shows some of the processing that can be performed by presence processing component 152 (in combination with the other components of system 102) and FIGS. 5A-5O are illustrative user interface displays that can be generated by user interface component 156, in performing this type of processing. FIGS. 1, 4 and 5A-5O will now be described in conjunction with one another.

It can first be seen that user 108 has accessed notebook 118 within notebook system 116, as described above. This is indicated by block 250 in FIG. 4. Presence detector 148 illustratively detects the presence of user 108 in notebook 118 and logs that information in data store 150. Presence processing component 152 then uses user interface component 156 to notify the other users within notebook system 116 of the presence of user 108 in notebook 118. Notifying the other users of the newly detected presence is indicated by block 252 in FIG. 4. This can be done in a number of different ways. For example, presence processing component 152 can generate a popup display for each of the other users indicating the identity and location of user 108 within notebook 118. This is indicated by block 254 in FIG. 4. Alternatively, or in addition, another type of widget display can be generated to indicate the presence of a user within notebook 118. This is indicated by block 256.

It may also be that one of the other users already in system 116 may send a message to user 108 that is to be delivered when the user logs onto system 116 or accesses a notebook within system 116. For instance, if user 110 wishes to collaborate with user 108 on a given section of notebook 118, user 110 may generate a message to user 108 that is delivered when user 108 logs onto system 102 and accesses notebook system 116. The message may be a text message, an email, a request for a conference call, etc. In any case, any messages intended for user 108 are then sent to user 108. This is indicated by block 258 in FIG. 4.

FIG. 5A is one illustrative user interface display 260 that is generated by component 156 and corresponds to a selected notebook. Display 260 shows a plurality of notebook displays 261 displayed vertically along the left side of display 260. By selecting different tabs 261, the user 108 can navigate among notebooks 118-120 in notebook system 116. Assume that user 108 has navigated to notebook 118, and notebook 118 corresponds to a “People Presence” notebook. In that case, component 152 controls component 156 to generate a user interface display representative of notebook 118. In the embodiment shown in FIG. 5A, the display 260 has a plurality of section tabs and section group tabs 262 displayed horizontally across the top of display 260 and a plurality of page tabs 264 displayed vertically along the right side of display 260. Also, in display 5A, user 108 has selected the “Spec Discussion” tab 266 so that the body 268 of display 260 shows a selected page for that section. The tab for the selected page is shown in white at 270 in the page tabs 264.

In one embodiment, the user can navigate between the various sections by simply clicking on or otherwise actuating the various section tabs 262. The user can navigate among different pages or documents within a selected section by clicking on or otherwise actuating a given page tab (or document tab within a page tab—these can also be referred to as subpage tabs) on the list of page tabs 264.

As discussed above, each of the individual pages 126-128 in a notebook 118 can, itself, be a document. Alternatively, each page can have multiple documents embedded thereon or one document embedded within another document, on a page. In the embodiment shown in FIG. 5A, the content section 268 of the displayed page includes a spreadsheet 272 which comprises a document on the selected page 270. Once the user has navigated to a specific notebook 118, and the notebook display has been generated as shown in FIG. 5A, presence processing component 152 illustratively accesses data in store 150 and generates a presence display for user 108, indicative of the presence of current users within notebook 118. This is indicated by block 280 in FIG. 4. This can be done in a wide variety of different ways.

FIG. 5B shows one embodiment of a user interface display 282 that can be generated to show detected presence within document 118. User interface display 282 is similar to user interface display 260 and similar items are similarly numbered. However, interface display 282 also includes a presence detection icon 284 which is arranged proximate page tab 270, and has the number 4 displayed next to it. This indicates that four people are currently on the page represented by page tab 270.

Presence indicator 284 is illustratively an actuable icon and can be displayed in a variety of different ways. For instance, it can be blinking, glowing, intermittently displayed, etc. Alternatively, it can be displayed only when a user hovers over page tab 270, or otherwise. In addition, display 282 may be provided with a presence indicator button which, when clicked by the user, displays presence indicator icon 284. In any case, presence indicator 284 is displayed showing the number of people and indicating (by its location relative to page 270) the number of people that are at a current location within notebook 218. Displaying the icons 284 proximate the location (e.g., proximate page tab 270) corresponding to the other user's location in notebook 118 or even within a document is indicated by block 290 in FIG. 4.

In another embodiment, the location of presence indicator 284 on display 282 is not related to the location of other people in notebook 118. Instead, the particular manner of display gives a general indication of the location of those users. For instance, the number 4 on display 284 is shown in parentheses. In one embodiment, this indicates that the users corresponding to that display icon 284 are in the same location as the current user. If the number is not displayed in parentheses, this may indicate that the other users are located elsewhere in notebook 118. In any case, display 284 indicates the presence of other users within notebook 118. Displaying icon 284, along with the number of people detected in the notebook 118, is indicated by block 286 in FIG. 4. Distinguishing between whether those people are located, at the same location (e.g., within the same document) as user 108 and those in other locations in notebook 118 is indicated by block 288.

In another embodiment, display 284 can be generated to indicate a user's location even within a document. By way of example, if a page corresponding to one of the page tabs 264 has a lengthy document in it, then display 284 may be displayed in such a way that it shows the individual user's location within that document. Similarly, if a video clip is embedded on a page, display 284 can show not only that a given user is viewing the video clip, but where in the video clip the user is currently. For instance, display 284 may include a textual portion such as “John Doe is currently viewing this video clip at 27:14:00.” This is also indicated by block 290 in FIG. 4.

Once the display 284 is generated, showing the presence of other users in a notebook, user 108 can interact with elements on the user interface display 282 and presence processing component 152 performs various operations based upon those user interactions. For instance, the user can interact with the presence display 284 in different ways to receive different information. By way of example, the user can hover over display 284, or the user can actuate display 284 by clicking on it. Receiving the user interaction with the presence display is indicated by block 292 in FIG. 4. Hovering is represented by block 294 and actuating or clicking the display 284 is represented by block 296 in FIG. 4. Other interactions are contemplated as well.

FIG. 5C shows another interface display 300. User interface display 300 is similar to user interface display 282 shown in FIG. 5B, and similar items are similarly numbered. However, user interface display 300 shows that user 108 has hovered the cursor over, or selected, presence display 284. In the embodiment shown in FIG. 5C, presence processing component 152 then generates, through user interface component 156, a pop-up display 302 that displays the identity of the four users represented by display element or display 284 (which is indicated generally along the left side of pop-up display 302) and the location within notebook 118, of each of those users (which is indicated generally along the right side of pop-up display 302). It will again be noted that pop-up display 302 is illustrative only. The identity of the other users in notebook 118 can be displayed in other ways, and their location can be displayed in other ways as well. In addition, other items can be displayed, fewer items, or a combination of different items can be displayed in display 302. Generating the identity and location display 302 and displaying the identity of other people who are present and their locations is indicated by block 304 in FIG. 4. Once display 302 is generated, user 108 can interact with it in various ways, and this will be described below.

FIG. 5D shows yet another user interface display 306 that can be generated by presence processing component 152 and user interface component 156. User interface display 306 is similar to user interface display 302, and similar items are similarly numbered. However, it can be seen that the number adjacent presence display element 284 is in parentheses. In one embodiment, the parentheses can be used to convey certain information. In the embodiment shown in FIG. 5D, the number 4 in parentheses adjacent element 284 indicates that the four other users present in notebook 118 are in the same location as user 108, who is viewing display 306. That is, the other four users are also in notebook 118, are also in the “Spec Discussion” section and are also viewing the “People Presence” page indicated by page tab 270. When the user hovers over, or selects, display 284, popup display 302 will indicate this. FIG. 5E shows user interface display 308, which is similar to user interface display 300 shown in FIG. 5C, except that it can now be seen that pop-up display 302 shows that the location of all four users is the same as the location of the present user 108. That is, all four users are in the same section (the “Spec Discussion” section) and they are all in the same document on the “People Presence” page.

FIG. 5F shows that another user interface display that can be generated by presence processing component 152 and displayed by user interface component 156. Display 310 is similar to display 306 shown in FIG. 5D, and similar items are similarly numbered. However, display 310 shows that presence display element 284 now has two numbers next to it. The first (number 16) is not in parentheses and the second (number 4) is in parentheses.

In one embodiment, this indicates that there are 16 people present in notebook 118 (which is the same notebook that user 108 is in) but they are at different locations in notebook 118 than is user 108. The number 4 in parentheses indicates that there are four users in notebook 118, and they are at the same location as the user 108.

Also, it will be appreciated that this information can be conveyed in different ways. For instance, a presence display element 284 can be displayed adjacent notebook tabs 261 to indicate how many people are in each of the notebooks in system 116. Similarly, different display indicator elements 284 can be displayed adjacent section tabs 262 to indicate how many people are in each section of the notebook 118. A presence display element 284 can also be displayed adjacent the various page tabs 264 to indicate the number of different users that are at different page locations within notebook 118. Also, where there are a plurality of different documents on a given page or embedded within a given page, a presence indicator element 284 can be displayed adjacent tabs corresponding to those different documents to indicate where different users are located even within a document. This can be done in other ways as well.

FIG. 5G shows another user interface display 319, which is similar to user interface display 308 shown in FIG. 5E, and similar items are similarly numbered. However, pop-up display 302 now shows four users in the same location as the present user 108 within notebook 118, and that there are additional users in different locations within notebook 118. The identity of the users is again displayed on the left hand side of display 302 and their location within notebook 118 is shown on the right hand side. In the embodiment shown in FIG. 5G, those in the same location as the present user 108 are displayed first in the list on display 102, and those in other locations are displayed later in the list. This could of course be done in other ways. For instance, the other users might be simply displayed in alphabetical order, regardless of location, or they can be displayed in order based on the time they began accessing notebook 118, or they can be displayed based on the frequency of edits they have made within notebook 118 (that is, heavy contributors to notebook 118 can be displayed higher up in the list), or otherwise.

Once the appropriate identity and location display 302 has been generated for the user 108, the user can interact with that display in various different ways, and presence processing component 152 can react in different ways, based on the user interaction. The user interaction with the identity and location display is indicated by block 320 in FIG. 4. The further processing based on the user interaction is indicated by block 322. A number of those different interactions will now be described.

FIG. 5H shows another user interface display 324 that indicates one possible user interaction. Display 324 is similar to display 319, except that it shows that the user has now moved the cursor to the upper right location in pop-up display 302. FIG. 5I shows that, in display 324, the user has scrolled down to the location that is fifth on the location list. Thus, it can be seen that the lists in pop-up display 302 are illustratively scrollable lists which contain actuable links. When the user has scrolled to the position shown in FIG. 5I, the user can actuate the link that is currently highlighted by tapping on it, clicking it, double clicking it, or pressing enter for that link. This causes system 116 to navigate the current user 108 to the highlighted location. Thus, this allows user 108 to jump to the location of another user, and this is indicated by block 326 in FIG. 4.

5J shows user interface display 328, which indicates that the user has now been navigated to the location represented by the actuated link in FIG. 5I. It will also be noted that the highlighted page tab is now tab 330 which corresponds to the tab currently being viewed by user 108. It can also be seen that presence display element 284 has been updated to show that there is only one other person at the current location of user 108. This is indicated by the numeral 1 being displayed in parentheses next to indicator 284. Indicator 284 also shows that there are 19 other users within notebook 118, but they are at different locations from the current user 108.

In another embodiment, the user can interact with the display to cause presence processing component 152 to display more detailed information about one or more of the other users in the system. FIG. 5K shows a user interface display 331, which is similar to user interface display 324, except that it shows that the user has moved the cursor over the first person's identity displayed on the left side of display 302 and has actuated the actuable link associated with that person.

In response, presence processing component 152 illustratively retrieves detailed identity information corresponding to that person from either data store 150 or from another data store. For instance, if network 104 is connected to a social media site, presence processing component 152 can retrieve information from that website or from any other source as well.

FIG. 5L shows another user interface display 332 which is generated by presence processing component 152 and user interface component 156 to display a business card display 334. Display 334 shows more detailed information about the person corresponding to the link actuated in FIG. 5K.

In another embodiment, the display 302 in FIG. 5I can operate using different user interactions as well. For instance, popup display 302 in FIG. 5I can display a single scrollable list where each line in the list shows the identity of a person and the person's location as one display element. When the user scrolls to a given line in the list, the given line can be highlighted. Then, the user can take different actions to accomplish different things. For example, if the user touches one key (such as the “Enter” key), the display changes to show more detailed information about the person in the highlighted line. When the user touches another key (such as the space bar) the user is navigated to the location in the highlighted line. Other ways of interacting can be used as well.

It will also be noted, in one embodiment, display 334 includes various other input mechanisms 336 that allow the user to perform other actions. For instance, they may allow the user 336 to communicate directly with the person for which the information is displayed through various communication mechanisms, and using communication component 114, and these are indicated by way of example only. Displaying the business card information (or more detailed information about a given user) is indicated by block 340 in FIG. 4.

In another embodiment, user 108 can interact with pop-up display 302 to directly initiate communication with another user in the list shown in pop-up display FIG. 302. FIG. 5M shows another user interface display 342 generated by processing component 152 and user interface component 156. FIG. 5M shows that pop-up display 302 illustratively includes a communication button 344. FIG. 5M also shows that user 108 has moved the cursor over button 344 to initiate communication with one or more of the users shown in display 302. The user actuates button 304, and processing component 152 illustratively generates another display using user interface component 156 to allow user 108 to initiate communications with one or more other users, using communication component 114. In one embodiment, in response to a user actuating button 344, processing component 152 generates a display using user interface component 156, offering user 108 a variety of different options for initiating communication. For instance, the display can display buttons to initiate instant messaging communication, communication by electronic mail (email), communications for initiating a video conference, a teleconference, a network-organized meeting, or other way of communicating. When the user selects that form of communication, presence processing component 152 illustratively accesses the appropriate communication component 114 for generating that communication. Initiating communication is indicated by block 346 in FIG. 4, and various exemplary forms of communication that can be initiated are indicated by blocks 348, 350 and 352. Of course, those shown are exemplary only.

FIG. 5N shows one illustrative user interface display 354 that can be generated to offer user 108 a specific form of communication. When the user actuates button 344, presence processing component 152 can generate another pop-up button, using user interface component 156, allowing the user to initiate instant messaging communication. This button is indicated at 356 in FIG. 5N. If the user actuates button 356, the user may then be asked to select the various users from list 344, that the user wishes to communicate with. When that is finished, component 152 generates a display of an instant messaging screen that allows the user to engage in instant messaging with the other selected users.

FIG. 5O shows yet another user interface display 358 that can be generated to initiate communication, once the user has actuated button 344. In the embodiment shown in FIG. 5O, component 152 generates a display with two additional, predefined options indicated by selectable interface elements 360 and 362. The option represented by element 360 allows a user to send an instant message to all other users that are currently at a given page location within notebook 118. The option represented by element 362 allows the user 108 to send a message or initiate communication with all other users in a given notebook 118-120, regardless of their location within that notebook. In response to the specific options shown in FIG. 5O, processing component 152 opens up an instant messaging chat session for all of the users corresponding to the selected option.

It should be noted that, while a number of different actions have been described and illustrated for presence processing component 152, a wide variety of others can be performed as well. For instance, in response to a user selection of an appropriate input mechanism, presence processing component 152 can generate a user interface display using user interface component 156, that allows a user to send an invitation to a group of users, for a collaboration meeting. That is, the display can provide a text box that allows a user to generate an invitation describing a meeting or a collaboration session on a given page, or within a given document on a given page, in a specific notebook, at a specific time. The display also allows the user to select recipients of the invitation, so the invitation can be sent to a group of recipients, at the same time. In response to the user inputting the necessary information, component 152 illustratively invokes communication component 114 to send the invitation by an appropriate communication mechanism. Sending such a group invitation is indicated by block 360 in FIG. 4.

In addition, presence processing component 152 can generate a user interface display using user interface component 156 that allows a user to query the location of a specific user. For example, the user interface display can include a user input mechanism which allows the user to input a textual query such as “where is John Doe?” or “what is John Doe's current location?” In that embodiment, presence processing component 152 accesses data store 150 to identify the present location of “John Doe” in notebook system 116, and provides that information to the user 108. Alternatively, of course, presence processing component 152 can automatically navigate the given user 108 to the location of “John Doe” in response to the query. The presence processing component 152 can also provide a navigable link to the user so that, when the user actuates that link, the user is automatically navigated to the current location of “John Doe”, and a variety of other mechanisms can be used as well. Querying for a location of another user is indicated by block 362 in FIG. 4. It will be appreciated that other steps can be taken by presence processing component 152, and those described above are exemplary only.

Further, while the above discussion has proceeded with respect to detecting and displaying people presence in real-time, it can also be used to display history or breadcrumb information. For instance, store 150 can maintain a history or record of where people have been detected in notebooks 118, 120. This information can also include time stamp information that shows when people were located at the recorded locations. This can be beneficial to help determine when certain edits were made in a given notebook, for instance. A user can illustratively access the historical or breadcrumb information by selecting a “History” tab to see the history for the entire system, an entire notebook or a portion thereof. The information can also illustratively be queried by a user, or certain displays can automatically be generated when a user enters a notebook. For example, a recent history display can show everyone who has recently accessed a notebook, along with the locations accessed and the time and date the access was made. Other displays can be used as well.

In another embodiment, users can opt out of having their presence detected. They can do this on a system wide level or on a more granular level (such as on a notebook level) or they can do this for certain users or user groups (so those users or groups will not see their presence). In one embodiment, the user can make such a setting temporary or permanent.

In yet another embodiment, a display can be generated that shows people that have access to a notebook, regardless of whether they are present. The user's current presence or absence can be indicated for each user as well, along with historical or breadcrumb information for each user.

It will be appreciated that the components of collaboration system 100 shown in FIG. 1 are exemplary only. The functions of those components can be combined into fewer components or divided among more components or combined in other ways. Also, collaboration system 100 can be deployed in a variety of different architectures and components of system 100 can be distributed among various client devices, servers, or located in a cloud computing architecture.

Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on a client device directly, or in other ways.

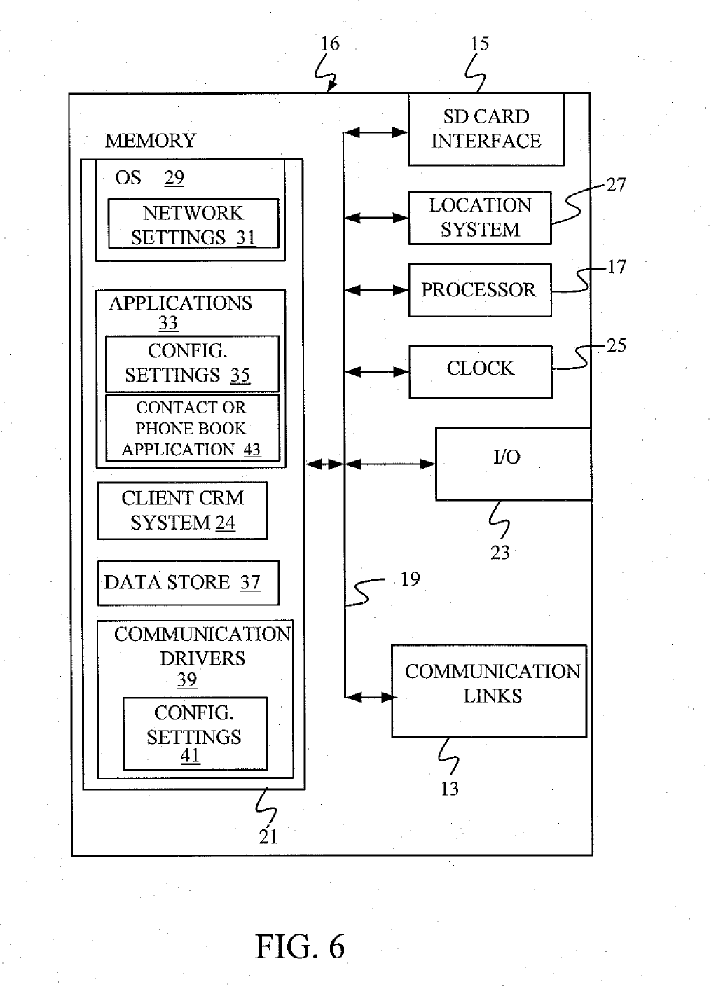

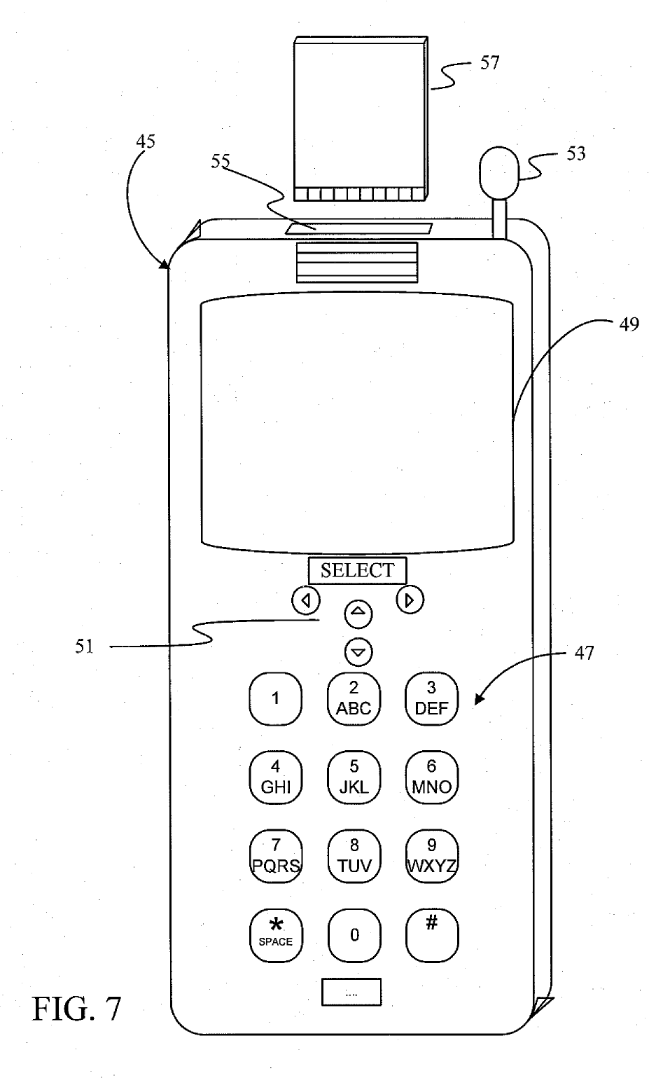

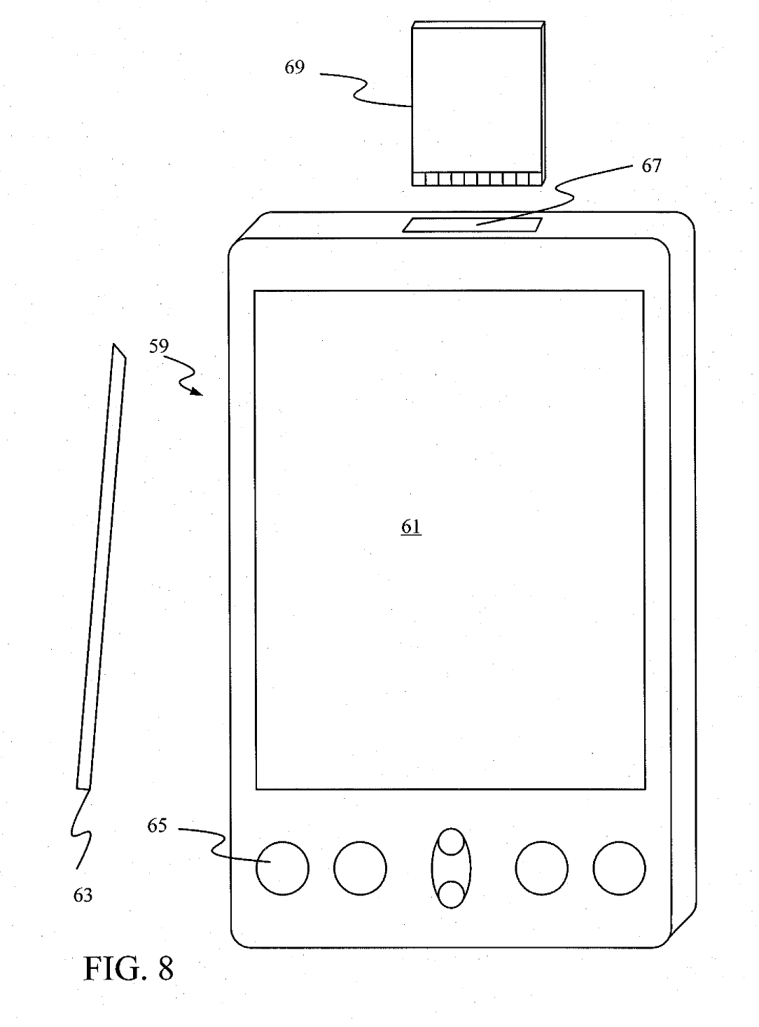

In any case, FIG. 6 is a simplified block diagram of one illustrative embodiment of a handheld or mobile computing device that can be used as a client device 16, in which the present system (or portions of the present system) can be deployed. FIGS. 7 and 8 are examples of handheld or mobile devices.

FIG. 6 provides a general block diagram of the components of a client device 16 that can run components of system 100 or 102 or that interacts with system 100 or 102, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100 or portions thereof) are received on a removable Secure Digital (SD) card that is connected to a SD card interface 15. SD card interface 15 and communication links 13 communicate with a processor 17 (which can also embody processor 146 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 150, for example, can reside in memory 21. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIGS. 7 and 8 provide examples of devices 16 that can be used, although others can be used as well. In FIG. 7, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible. Examples include tablet computing devices, music or video players, and other handheld or mobile computing devices.

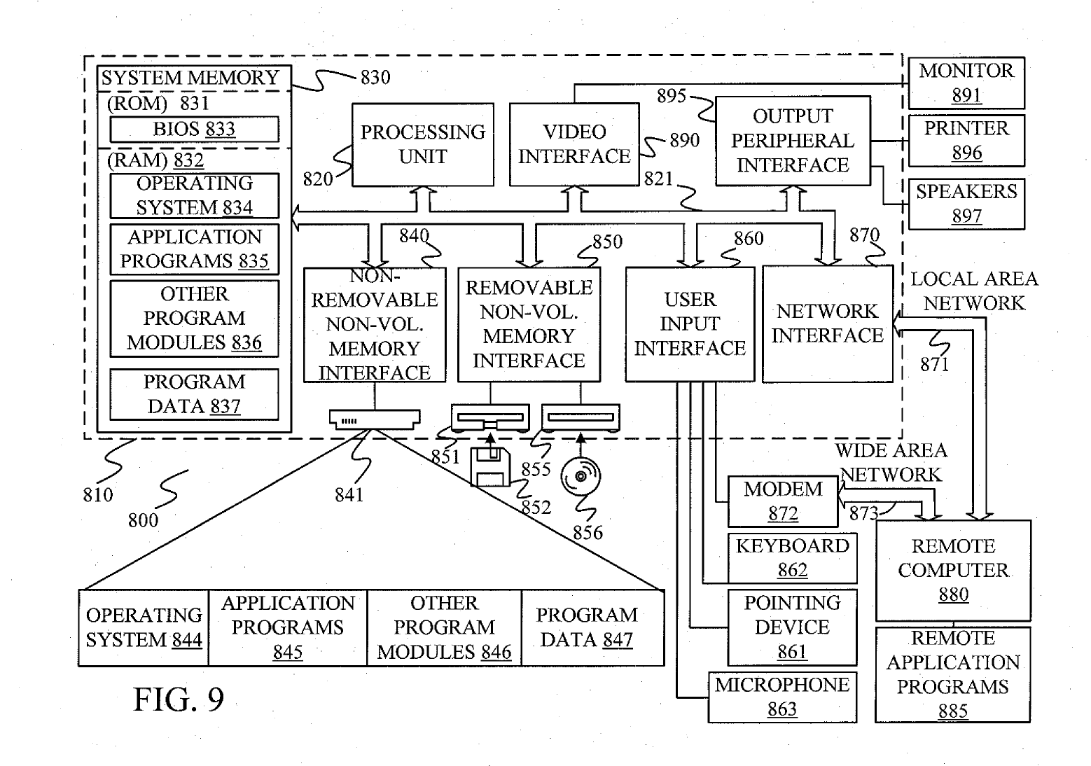

FIG. 9 is one embodiment of a computing environment in which system 100 (or portions of system 100, for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor 146 in FIG. 1), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of processing collaborator presence in a collaboration system, comprising:
detecting a first location, being accessed by a first user, in a collaboration system that includes a plurality of different documents;
storing the first location and an identity of the first user in a data store;
detecting access, by a second user, to the collaboration system; and
generating a user presence display for the second user indicating that another user is accessing the collaboration system at a given location.

2. The computer-implemented method of claim 1 and further comprising:
receiving a first user interaction with the user presence display from the second user; and
in response, modifying the user presence display for the second user to include the identity of the first user along with the first location being accessed by the first user in the collaboration system.

3. The computer-implemented method of claim 2 and further comprising:
detecting navigation of the first user to a different location in the collaboration system, different from the first location; and
updating the first location of the first user stored in the data store to the different location to which the first user has navigated.

4. The computer-implemented method of claim 3 and further comprising:
updating the user presence display for the second user to indicate that the first user has navigated to the different location in the collaboration system.

5. The computer-implemented method of claim 1 wherein generating the user presence display for the second user, comprises:
generating the user presence display for the second user to indicate a number of other users currently accessing the collaboration system and a number of the other users that are at a same location in the collaboration system as the second user and a number of the other users that are at another location in the collaboration system, other than the location of the second user.

6. The computer-implemented method of claim 5 and further comprising:
modifying the user presence display for the second user to generate an identity and location display showing the identity of the other users along with an indication of the location being accessed by the other users in the collaboration system.

7. The computer-implemented method of claim 6 wherein modifying the user presence display to generate the identity and location display comprises:
generating an actuable identity display element corresponding to each of the other users and providing a first set of identity details for the corresponding other user; and
in response to actuation of the actuable identity display element, displaying additional identity details identifying the corresponding other user, in addition to the first set of identity details.

8. The computer-implemented method of claim 7 wherein modifying the user presence display to generate the identity and location display comprises:
generating an actuable location display element corresponding to a location in the collaboration system of each of the other users; and
in response to actuation of the actuable location display element by the second user, navigating the second user to the location in the collaboration system corresponding to the actuable location display element.

9. The computer-implemented method of claim 6 generating the identity and location display, comprises:
displaying an actuable communication display element; and
in response to user actuation of the actuable communication display element, accessing a communication component to generate communication with at least one selected user of the other users.

10. The computer-implemented method of claim 1 and further comprising:
generating a user presence display for the first user indicating that the second user is accessing the collaboration system at a second location.

11. The computer-implemented method of claim 10 wherein generating a user presence display for the first user comprises:
detecting the second location of the second user in the collaboration system; and
generating the user presence display for the first user indicating whether the first user is at a same or different location as the second user.

12. The computer-implemented method of claim 1 wherein detecting a first location comprises:
detecting where the first user has navigated to in the collaboration system.

13. The computer-implemented method of claim 1 wherein detecting a first location comprises:
detecting that the first user has begun to edit content at the first location.

14. The computer-implemented method of claim 1 wherein the collaboration system comprises a notebook system that has a plurality of different notebooks, each notebook having a plurality of different sections and each section having a plurality of different pages with one or more documents disposed thereon, and wherein detecting a first location comprises:
detecting a page in a section in a notebook at which the first user is located.

15. The computer-implemented method of claim 1 and further comprising:
generating the user presence display to show all other users that have access to the collaboration system and to indicate whether each of the other users is present in, or absent from, the collaboration system.

16. The computer-implemented method of claim 1 and further comprising:
receiving a user input from the first user indicating the first user is opting out of access detection; and
in response, generating the user presence display without indication that the first user is accessing the collaboration system.

17. A collaboration system, comprising:
a notebook system that provides a plurality of different notebooks, each notebook having a plurality of different documents, the notebook system being accessible by a plurality of different users;
a presence detector detecting that any of the plurality of different users are accessing the notebook system and a corresponding location of the notebook system being accessed;
a data store storing identity data indicative of an identity of a user detected by the presence detector and location data indicative of the corresponding location being accessed by the user;
a presence processing component generating a presence display to other users indicative of the identity data and the location data; and
a computer processor being a functional component of the collaboration system and activated by the notebook system, the presence detector and the presence processing component to facilitate detecting and generating the presence display.

18. The collaboration system of claim 15 wherein the notebook system generates a notebook display indicative of a notebook selected by a given user and one of the documents within the selected notebook to which the given user has navigated.

19. The collaboration system of claim 18 wherein the presence processing component, in response to user actuation of an actuatble link, generates a history display showing where and when other users accessed the notebook system.

20. A computer-implemented method of processing collaborator presence in a collaboration system, comprising:
detecting a first location, being accessed by a first user, in a collaboration system that includes a plurality of different documents;
storing the first location and an identity of the first user in a data store;
detecting access, by a second user, to the collaboration system;
generating a user presence display for the second user indicating that another user is accessing the collaboration system at a given location;
detecting the second location of the second user in the collaboration system;
generating the user presence display for the first user indicating whether the first user is at a same or different location as the second user;
detecting navigation of the first user to a different location in the collaboration system, different from the first location;
updating the first location of the first user stored in the data store to the different location to which the first user has navigated; and
updating the user presence display for the second user to show the different location of the first user.
